(19) United States
(12) Patent Application Publication
(10) Pub. No.: US 2009/0145808 A1
(43) Pub. Date: Jun. 11, 2009

(54) CATALYST TO ATTAIN LOW SULFUR DIESEL

(75) Inventors: Ki-Hyouk Choi, Dhahran (SA); Isao Mochida, Higashi-Ku (JP)

Correspondence Address: BRACEWELL & GIULIANI LLP, P.O. BOX 61389, HOUSTON, TX, 77208-1389, US

(73) Assignee: SAUDI ARABIAN OIL COMPANY, Dhahran (SA)

(21) Appl. No.: 12/276,981

(22) Filed: Nov. 24, 2008

Related U.S. Application Data
(60) Provisional application No. 60/991,382, filed on Nov. 30, 2007.

(51) Int. Cl. C10G 45/08; B01J 23/30; B01J 23/26; B01J 23/28; B01J 23/652; B01J 23/86; B01J 23/881; B01J 23/883; B01J 27/049; B01J 21/08; B01J 27/051; B01J 21/02; B01J 27/188; B01J 27/19; B01J 27/186; C10G 45/10; C10G 45/04

(52) U.S. Cl. 208/216 R; 502/305; 502/319; 502/321; 502/313; 502/315; 502/316; 502/219; 502/220; 502/254; 502/255; 502/256; 502/204; 502/206; 502/210; 502/211

(57) ABSTRACT

This invention relates to a hydrodesulfurization catalyst and a method for preparing the catalyst by spray pyrolysis. The catalyst is useful for the hydrodesulfurization of gas oils, particularly diesel. The catalyst particles can include at least one metal selected from molybdenum, cobalt and nickel, and a silicon dioxide support. The spray pyrolysis technique allows for the preparation of catalyst particles having high loading of catalyst on the substrate.

### RELATED PATENT APPLICATION

This patent application claims priority to U.S. Provisional Patent Application Ser. No. 60/991,382, filed on Nov. 30, 2007, which is incorporated by reference in its entirety.

### BACKGROUND OF THE INVENTION

1. Technical Field of the Invention

This invention generally relates to the field of hydroprocessing catalysts for treatment of hydrocarbons. In particular, the present invention is directed to a process for preparing a catalyst useful for the hydrodesulfurization of diesel feedstock.

2. Description of the Prior Art

In the petroleum industry, it is common for gas oils, particularly middle distillate petroleum fuels, to contain sulfur species. Engines utilizing petroleum based fuels which include sulfur can produce emissions of nitrogen oxide, sulfur oxide and particulate matter. Government regulations have become more stringent in recent years with respect to allowable levels of the potentially harmful emissions.

Various methods have been proposed to reduce sulfur levels in gas oils. However, there are disadvantages associated with previously proposed methods for reducing sulfur levels in gas oils. For example, hydrodesulfurization of fuel in catalytic reactors has been proposed, however the process frequently requires two or more reactors operating in series under low flow rates and high temperatures, pressures and hydrogen consumption conditions. The severe reaction conditions are necessary to overcome strong inhibition of refractory sulfur and nitrogen compounds against hydrodesulfurization. Therefore, strict conditions are also imposed on apparatus design, thereby typically incurring high construction costs.

Alternatively, various organic and inorganic adsorbents have been proposed to effectuate adsorptive removal of sulfur compounds. Examples of previously proposed adsorbents include silica, alumina, zeolite, activated carbon, activated carbon-based fiber materials and spent hydrodesulfurization catalyst. However, the volumetric adsorption capacity for these adsorbents was often too low, and breakthrough of sulfur compounds into the fuel product are often too rapid. Also, inorganic adsorbents typically require high temperature treatment for regeneration, which is not practical for stable and continuous operation, and the adsorption regeneration cycle is too frequent, which makes efficient operation difficult. Further, these adsorbents often can be expensive and susceptible to attrition. Fine particles produced due to attrition between adsorbent particles can cause plugging and high pressure drops, each of which can shorten the run length of an adsorption process.

Alumina is commonly used as a support material for catalyst compositions, but suffers from several disadvantages in the hydrodesulfurization of petroleum distillates. Alumina, which is acidic, generally can not be well suited for desulfurization of diesel fractions because the diesel fraction can include nitrogen compounds, such as for example quinoline and carbazole. As a basic species, nitrogen containing compounds can bind to acidic sites on the surface of the alumina and the catalyst, thereby limiting the number of surface sites which are available for sulfur compounds for desulfurization with the aid of hydrogen. At the same time, nitrogen containing compounds having aromatic rings are easily transformed into coke precursors, resulting in rapid coking of the catalyst.

In addition, prior art methods suffer in that the preparation of desulfurization catalysts having high metal loading with high dispersion is generally difficult. For example, many prior art catalysts can be prepared by a conventional impregnation method wherein the catalysts can be prepared by mixing the support materials with a solution that includes metal compounds, followed by filtration, drying, calcination and activation. However, catalyst particles prepared by this method are generally limited in the amount of metal which can be loaded to the support material with high dispersion, which generally does not exceed approximately 10% by weight of metal to support materials having a relatively high surface area, such as for example, silicon dioxide. Attempts to achieve a higher loading of the metal to a support material having a relatively high surface area, such as silicon dioxide, typically result in the formation of aggregates of metallic compounds on the surface of the support. In addition, the conventional impregnation method can take several days to produce the calcinated catalyst particles. Similar deficiencies are present in catalyst particles produced by a co-precipitation method.

Thus, catalyst compositions and methods for preparing catalysts useful for the removal of sulfur species from petroleum based products are needed. Specifically, methods for the production of the catalyst compositions which include support materials having high surface area and high catalyst loading with high dispersion for the desulfurization of petroleum products are desired.

### SUMMARY OF THE INVENTION

A hydrodesulfurization catalyst composition and its method of preparation are described. The catalyst particles include at least one active metal and a support material and which are prepared by a spray pyrolysis method.

In one aspect, a method for preparing a hydrosulfurization catalyst is provided. The method includes the steps of preparing a solution that includes at least one metal salt, a catalyst support and water; producing aerosolized droplets of the solution; heating the droplets to produce a solid catalyst particles; and collecting the solid catalyst particles. The metal salt includes a first metal selected from the group consisting of chromium, molybdenum, and tungsten. The catalyst thus created is useful in hydrodesulfurization and advantageously demonstrates higher activity than other commercially available catalysts.

In one embodiment, the solution further includes a second metal salt, wherein the second metal salt includes a metal selected from the group consisting of iron, ruthenium, osmium, cobalt, rhenium, iridium, nickel, palladium and platinum. Preferred catalyst compositions are cobalt-molybdenum and nickel-molybdenum.

In another embodiment, the method further includes calcinating the solid catalyst particles after collection. In another embodiments the step of calcinating the solid catalyst particles includes heating the particle to a temperature greater than about 400° C. In certain embodiments, the method further includes the step of partially sulfiding the catalyst particles. The step of partially sulfiding the solid particles can include contacting the particles with a hydrogen gas stream comprising hydrogen sulfide.

In another aspect, a catalyst composition is provided that includes a silicon dioxide catalyst support material; a first metal selected from the group consisting of chromium, molybdenum and tungsten; and a second metal selected from the group consisting of iron, ruthenium, osmium, cobalt, rhenium, iridium, nickel, palladium and platinum. The first metal is present in the oxide form of the metal and is present in a weight ratio of the first metal to the catalyst support material of greater than about 13% by weight. In certain embodiments, the weight ratio of the first metal to the catalyst support is between about 13% and about 23% by weight. In certain embodiments, the catalyst composition includes boron. In certain embodiments, the catalyst composition includes phosphorous.

In another aspect, a method for the hydrodesulfurizing a petroleum based hydrocarbon distillate of crude oil is provided that includes the step of contacting the petroleum hydrocarbon distillate with hydrogen gas in the presence of a hydrodesulfurization catalyst, wherein the hydrodesulfurization catalyst includes a silicon dioxide catalyst support material, a first metal selected from the group consisting of chromium, molybdenum and tungsten, and a second metal selected from the group consisting of iron, ruthenium, osmium, cobalt, rhenium, iridium, nickel, palladium and platinum, and wherein the catalyst is prepared by a spray pyrolysis technique. The spray pyrolysis technique includes the steps of preparing a solution comprising a first metal salt, a second metal salt, a catalyst support and water; producing aerosolized droplets of the solution; heating the droplets to produce solid catalyst particles; and collecting the solid catalyst particles. The first metal salt can includes a first metal selected from the group consisting of chromium, molybdenum, and tungsten; and the second metal salt can include a second metal selected from the group consisting of iron, ruthenium, osmium, cobalt, rhenium, iridium, nickel, palladium and platinum.

### BRIEF DESCRIPTION OF THE DRAWINGS

So that the manner in which the features, advantages and objects of the invention, as well as others that will become apparent, can be understood in more detail, more particular description of the invention briefly summarized above can be had by reference to the embodiment thereof which is illustrated in the appended drawings, which form a part of this specification. It is to be noted, however, that the drawings illustrate only a preferred embodiment of the invention and is therefore not to be considered limiting of the invention's scope as it can admit to other equally effective embodiments.

FIG. 1 depicts a schematic of one embodiment of a process of producing desulfurized diesel with the catalyst of the invention.

FIG. 2 depicts one embodiment of a process of producing a desulfurization catalyst.

FIG. 3A is an SEM image of the surface of a desulfurization catalyst prepared according to the present invention.

FIG. 3B is the SEM image of FIG. 3A on higher magnification.

### DETAILED DESCRIPTION OF THE INVENTION

In one aspect, a catalyst composition is provided for the removal of sulfur from petroleum hydrocarbon fuels. In particular, the catalyst composition is useful in the removal of sulfur from middle distillates produced at distillation temperatures typically ranging from about 200° C. to about 450° C., such as for example, diesel fuel. The catalyst composition is useful for the removal of sulfur from petroleum hydrocarbon fuel in the presence of hydrogen at elevated temperatures.

The catalyst includes a catalytic support material. The support material can include ultra stable Y zeolite, MCM-41 mesoporous material, β-zeolite, amorphous silica alumina, silicon dioxide, titanium dioxide, alumina, and combinations thereof. The support material preferably has a surface area of greater than about 200 m²/g. In certain other embodiments, the surface area of the support material is at least about 300 m²/g. One preferred catalyst support material is silicon dioxide, such as for example, Aerosil 300, which is a silicon dioxide support materials having a surface area of approximately 300 m²/g. In certain embodiments, the catalytic support material can have a diameter of less than about 20 nm. In certain other embodiments, the catalytic support material can have a diameter of less than about 15 nm. In yet other embodiments, the catalytic support material can have a diameter of less than about 10 nm.

The catalyst composition can include at least one metal selected from Group VIB of the periodic table, which includes, chromium, molybdenum and tungsten. The catalyst can also include at least one promoter metal selected from Group VIIIB of the periodic table, which include iron, ruthenium, osmium, cobalt, rhenium, iridium, nickel, palladium and platinum, as the active component. In certain embodiments, the catalyst composition can include more than one Group VIIIB metal. In a preferred embodiment, the catalyst includes molybdenum. In certain other embodiments the catalyst composition can include either cobalt or nickel. In certain other embodiments, the catalyst composition can include molybdenum, nickel and cobalt. In certain embodiments, at least a portion of the metal can be present as a metal sulfide. In certain other embodiments, at least a portion of the metal can be present as a metal oxide.

The metal can be present in oxide form and can be loaded onto the support material in an amount exceeding approximately 10% by weight of the support material. In other embodiments, the metal oxide can be loaded onto the support material in an amount exceeding approximately 15% by weight of the support material. In yet other embodiments, the metal oxide can be loaded onto the support material in an amount exceeding approximately 20% by weight of the support material. In yet other embodiments, the metal oxide can be loaded onto the support material in an amount exceeding approximately 23% by weight of the support material. In certain preferred embodiments, the metal oxide can be MoO₃.

Known catalyst promoters can also be added to the catalyst composition. Exemplary catalyst promoters include, but are not limited to, boron and phosphorous.

The catalyst composition can be subjected to calcining or similar thermal treatment, which can be beneficial in increasing the thermal stability and metal dispersion of the catalyst composition. Generally, during calcination of the catalyst, the particles are heated in an oxygen containing environment to temperatures ranging from about 200° C. to about 800° C. The process can be carried out by placing the composition in a process heater, at the desired temperature, with a flowing oxygen containing gas, such as for example, atmospheric air. The process heater can be heated to the designated temperature or temperature range, maintained at the designated temperature for a defined time period, and then cooled to room temperature. The calcination step can include heating the catalyst particles at a defined ramp rate.

Catalyst Preparation

In another aspect, a method for preparing a hydrodesulfurization catalyst composition by spray pyrolysis is provided. A solution is prepared by dissolving at least one metal salt in water and adding a catalytic support material. Exemplary catalytic support materials can include ultra stable Y zeolite, MCM-41 mesoporous material, β-zeolite, amorphous silica alumina, silicon dioxide, titanium dioxide, alumina, and combinations thereof.

In certain embodiments, the catalyst support material is preferably neutral or basic, when compared to the gamma-type alumina, which is generally used as the support material for desulfurization catalysts. For use in the desulfurization of hydrocarbon streams that can include nitrogen containing compounds, the catalyst support material is preferably not acidic, as it is believed that acidic sites on a support material can attract basic compounds or nitrogen containing compounds. Nitrogen containing compounds or basic compounds which become bound or coupled to the surface of the support material can block catalyst sites and induce rapid coking, thus reducing the overall effective catalyst loading and activity.

Catalyst support materials having a high surface area allows for greater loading of the active species which provide the catalytic activity. Thus, catalyst support materials having a relatively high surface area are preferred. In certain embodiments, the catalyst support material surface area can be at least about 200 m²/g. Preferably, the catalyst support material surface area is at least about 270 m²/g.

Additionally, it is preferable that the support material particles are sufficiently small that they can be aerosolized. In certain embodiments, the catalyst support material particles are less than about 50 nm in diameter, preferably less than about 25 nm in diameter, and even more preferably less than about 20 nm in diameter. In certain other embodiments, the catalyst support material particles can be less than about 15 nm in diameter. In yet other embodiments, the catalyst support material particles can be less than about 10 nm in diameter.

One exemplary catalyst support material having low acidity and high surface area is silicon dioxide. Aerosil 300 is one exemplary silicon dioxide catalyst support material that can be advantageously used to prepare hydrodesulfurization catalysts, according to the methods described herein.

Exemplary metal salts can include salts of the Group VIB metals of the periodic table, which include chromium, molybdenum and tungsten. In certain embodiments, exemplary metal salts can include salts of the VIIIB metals, which include iron, ruthenium, osmium, cobalt, rhenium, iridium, nickel, palladium and platinum. In certain embodiments, the metal salt includes a metal selected from cobalt, molybdenum and nickel. In certain embodiments, more than one metal salt can be added to the solution, wherein at least one of the metals is selected from cobalt, molybdenum and nickel. Preferably, the metal salt(s) and catalyst support material are sufficiently mixed to produce a homogeneous aqueous solution that contains the metal salt and the support material. Specific examples of metal salts which can be employed according to the methods disclosed herein include, but are not limited to, (NH₄)₆Mo₇O₂₄.4H₂O, Ni(NO₃)₂.6H₂O, Co(NO₃)₂.6H₂O, NiCl₂.6H₂O, CoCl₂.6H₂O, (NH₄)₆H₂W₁₂O₄₀.XH₂O (ammonium metatungstate) and the like. Carbonates of nickel and cobalt can be used as precursors, although an acid, such as for example phosphoric acid, must be added to the solution to aid in solubility of the carbonates. Nickel and cobalt acetates can also be used as precursors, although, for purposes of solubility, organic solvents may be required. Finely ground particles of molybdenum trioxide can also be used to prepare a colloidal precursor solution.

Aerosol droplets of the metal salt-catalytic support solution can be prepared by aerosolization of the solution, such as for example, by using an ultrasonic nebulizer. Preferably, droplets are produced that are small enough to be carried via a carrier gas. Any gas can be used as a carrier gas, such as for example, air or nitrogen. In certain embodiments, an ultrasonic nebulizer can be directly coupled to the vessel used for preparing the metal salt-catalytic support material solution. In certain other embodiments, the metal salt-catalytic support material solution can be prepared and supplied to a vessel which is coupled to an ultrasonic nebulizer or other means for generating aerosolized particles.

The aerosolized droplets can be dried by passing the aerosolized droplets through a heated tube via the carrier gas. The dried particles can then be collected as solid particles. In certain embodiments, the drying step can take place in multiple steps. In an exemplary embodiment, the aerosolized droplets can be supplied via a carrier gas to a pre-heating tube which can be maintained at an elevated temperature, such as for example, between about 100° C. and about 400° C. Preferably the pre-heating tube can be maintained at a temperature between about 150° C. and about 300° C. The pre-heated aerosolized droplets can then be fed to a pyrolysis tube which can be maintained at a temperature between about 200° C. and about 800° C. Preferably, the pyrolysis tube is maintained at a temperature between about 400° C. and about 600° C. Pyrolysis of the aerosolized droplets in the presence of oxygen can facilitate the production of metal oxide on the surface of the catalyst particles.

Each aerosol droplet can form individual secondary particles which contain all the necessary components for the catalyst. Uniform heating of the particles in the spray pyrolysis can result in uniform thermal treatment of the particles. Thus, in certain embodiments, the spray pyrolysis process can produce spherical particles having a uniform diameter. In addition, the spray pyrolysis process can result in particles which include a layer of active catalytic metals on the surface of the support material of uniform depth.

The dried catalyst particles can be, supplied from the drying apparatus to a collection vessel. The dried catalyst particles can be collected by a variety of means. In an exemplary embodiment, a glass fiber filter can be connected to the pyrolysis tubes such that the carrier gas carries dried catalyst particles to the filter. In certain embodiments, the filter can be heated. Heating the collection filter can help to prevent the condensation of water and other condensable vapor on the catalyst particles. In certain embodiments, multiple collection vessels arranged in parallel fashion can be employed for the collection of particles. In certain other embodiments, the spray pyrolysis apparatus can include valves operably coupled to a plurality of collection vessels, allowing for the collection vessels to be individually isolated from the remainder of the system, allowing for removal of the collected particles.

The particles can be calcinated after collection and drying at a temperature from approximately 400° C. to 550° C. In certain embodiments, the catalyst particles can be calcinated at a temperature of approximately 500° C. The catalyst particles can be calcinated for between 30 minutes and 8 hours, preferably for between about 3-6 hours. In an exemplary embodiment, the catalyst particles are calcinated at a temperature of approximately 500° C. for a period of approximately 4 hours.

After being dried and collected, the catalyst particles can be contacted with a sulfur containing source. In one embodiment, the sulfur source is a hydrogen gas stream which includes up to approximately 5 vol % hydrogen sulfide. In certain embodiments, the hydrogen gas stream includes approximately 1 vol % hydrogen sulfide. In certain embodiments, the catalyst particles can be contacted with a sulfur source at a temperature of greater than about 200° C., preferably at temperatures greater than about 300° C. In an exemplary embodiment, the catalyst particles can be contacted at a temperature of approximately 360° C. Preferably, the sulfur containing hydrogen gas can contact the catalyst particles for an extended period of time, such as for example, at least one hour, or more preferably, at least two hours. The effluent leaving the catalyst during pre-sulfiding has sulfur content lower than that of the effluent being fed, thus showing active sulfidation of the catalyst particles. In certain embodiments, the calcinated particles can be sulfided as described above.

In certain embodiments, the catalyst particles can be prepared in a batch process wherein a volume of metal salt-catalyst support material solution is prepared and the particles can be prepared therefrom. In certain other embodiments, the catalyst particles can be prepared in a continuous process wherein the mixing vessel is continuously supplied with water, one or more metal salts, and a catalyst support material.

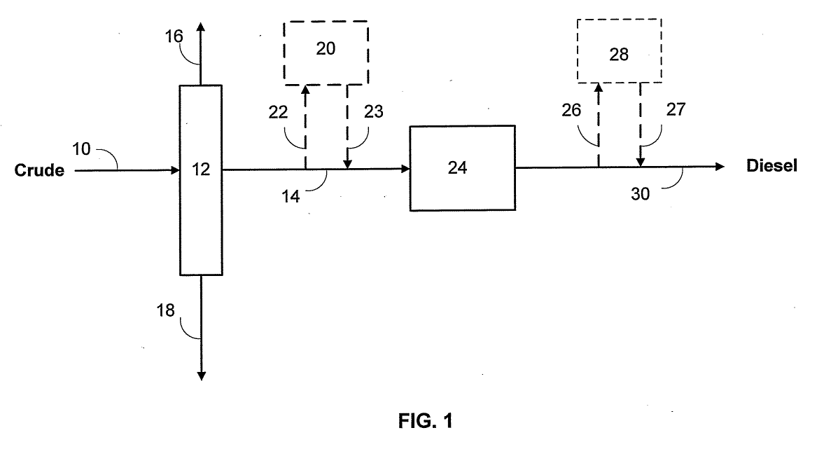

Referring now to FIG. 1, a process for the production of diesel fuel is provided. A crude oil source, which has been optionally upgraded following production, is supplied via line 10 to atmospheric distillation column 12, from which middle distillate gas oil fraction 14 can be obtained. A liquefied petroleum gas fraction and light distillate 16 can be collected from the top of the distillation column and resid fraction 18 can be collected from the bottom of the distillation column. Gas oil fraction 14 can optionally be supplied to pretreatment process 20 to produce pre-treated gas oil fraction 23. Pre-treated fraction 23 can then be supplied to hydrodesulfurization unit 24, which can include a hydrodesulfurization catalyst prepared according to the methods described herein, to produce a desulfurized gas oil fraction. Desulfurized gas oil fraction 26 can optionally be supplied to post-treatment process 28, to produce desulfurized diesel fraction 30.

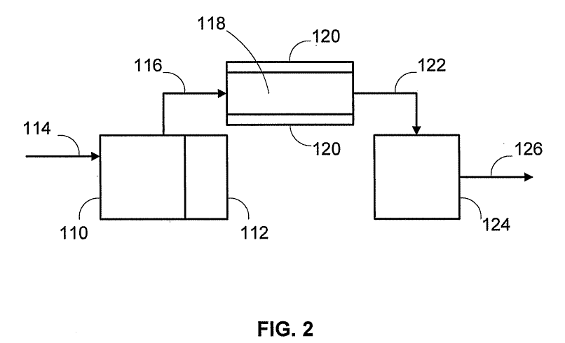

Referring now to FIG. 2, an exemplary apparatus for the production of catalyst particles according to the present method is provided. Mixing vessel 110 is provided which includes a source for producing aerosolized particles 112, a carrier gas source and inlet 114, and an outlet 116. Optionally, the mixing vessel can include means for mixing the reactants, including but not limited to, an ultrasonic bath and/or mechanical stirring means, as is known in the art. Outlet 116 from mixing vessel 110 is coupled to drying chamber 118, which can include heating source 120. As shown, heating source 120 is positioned about the exterior of drying chamber 118, although it is understood that heating elements can be positioned about the drying chamber in a variety of ways. In certain embodiments, heating source 120 can be located on one side of drying chamber 118, and in other embodiments, multiple heating sources can be placed about the drying chamber. Optionally, a heating element can be positioned within outlet 116 to pre-heat the aerosolized particles prior to entering drying chamber 118. In certain embodiments, drying chamber 118 can include a pre-heating tube and a pyrolysis tube. Drying chamber 118 can be coupled via line 122 to means for collecting 124 the dried aerosolized particles. In certain embodiments, collection means 124 can include a filter which includes pores which are smaller than the catalyst particles, thus allowing the carrier gas to be vented from the reaction system via line 126.

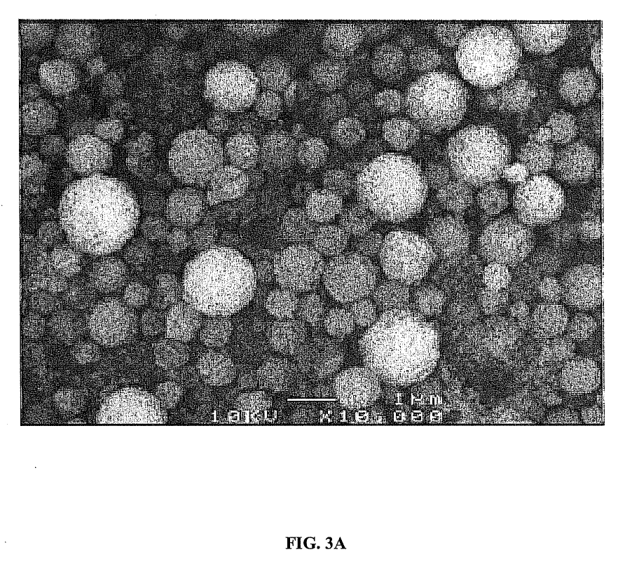

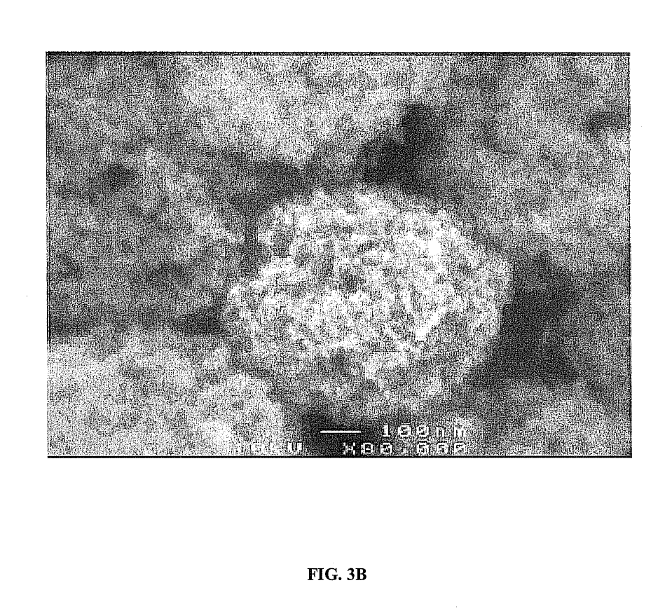

Referring now to FIGS. 3A and 3B, scanning electron microscopy images of a cobalt-molybdenum catalyst on an alumina support material prepared according to the methods described herein are provided. As shown in the figures, the metal particles form a well dispersed monolayer of cobalt and molybdenum particles on the alumina surface, which includes approximately 16 wt. % MoO₃ and approximately 3 wt. % CoO. (See Choi, Applied Catalysis A: General, 260, 2004, 229-236).

### EXAMPLES

Catalyst particles containing nickel and molybdenum and a silicon dioxide support material were prepared according to the methods described herein and tested for desulfurization activity. Five samples were prepared having a weight ratio of surface bound molybdenum oxide to silicon dioxide of between about 5% and about 25%. The ability of the catalyst to remove sulfur from a partially desulfurized straight run gas oil, having an initial sulfur content of approximately 350 ppm sulfur, were then compared with a commercially available nickel-molybdenum hydrodesulfurization catalyst, having an alumina base and prepared according to conventional impregnation methods.

### Example 1

### NM5Si

An aqueous solution was prepared by dissolving 0.326 g of (NH₄)₆Mo₇O₂₄.4H₂O (WAKO Chem.) and 0.194 g of Ni(NO₃)₂.6H₂O in 400 mL of water. To the aqueous solution, 5 g of silicon dioxide (Aerosil 300) was added and dispersed with the aid of an ultrasonic bath to obtain a homogeneous solution. Spray pyrolysis of the solution was carried out with an apparatus consisting of an aerosol generator, a pre-heating tube, a main pyrolysis tube and a filter. The solution was aerosolized with an ultrasonic nebulizer and transported via carrier gas to the pre-heating tube, which was maintained at approximately 200° C. The aerosolized solution was then transported to the main pyrolysis tube, which was maintained at approximately 500° C. Pure nitrogen having flow rate of 3 L/min was used as a carrier gas to carry the aerosol droplets from the nebulizer, through the tubes, and to the filter. Powder formed in main pyrolysis tube was collected with a glass fiber filter having a pore diameter of 0.5 μm, which was heated to approximately 120° C. to prevent vapor condensation on the powder. The as-collected catalyst powder was calcinated at 500° C. for 4 hr in air. The as-collected and post-calcinated catalyst powders were pre-sulfided with hydrogen gas containing 5 vol % of H₂S at approximately 360° C. for approximately 2 hours before testing in hydrodesulfurization.

Hydrodesulfurization of a sample of partially desulfurized straight run gas oil (DSGO) was conducted with a 100 mL batch type stirred reactor charged with 0.5 g of sulfided catalyst (NM5Si), 10 g of partially partially desulfurized straight run gas oil (having a sulfur content of 350 wt ppm sulfur) and 50 kg/cm² hydrogen at room temperature. Hydrodesulfurization was conducted at a temperature of approximately 340° C. for a reaction time of 2 hours. After 2 hours, a small amount of the product was sampled through small sampling tube. The total pressure during reaction was approximately 70 kg/cm². The feed gas oil and reaction product were analyzed by GC-AED (HP 6890+ and G2350A) to obtain total sulfur content and sulfur-specific chromatograms, as provided in Table 1.

### Example 2

### NM10Si

An aqueous solution was prepared by dissolving 0.696 g of (NH₄)₆Mo₇O₂₄.4H₂O (WAKO Chem.) and 0.414 g of Ni(NO₃)₂.6H₂O in 400 mL of water. To the aqueous solution, 5 g of silicon dioxide (Aerosil 300) was added and dispersed with the aid of an ultrasonic bath to obtain a homogeneous solution. Spray pyrolysis was carried out with an apparatus consisting of an aerosol generator, a pre-heating tube, a main pyrolysis tube and a filter. The solution was aerosolized with an ultrasonic nebulizer and transported via a carrier gas to the pre-heating tube, which was maintained at approximately 200° C. The aerosolized solution was then carried to the main pyrolysis tube, which was maintained at approximately 500° C. Pure nitrogen having flow rate of 3 L/min was used as a carrier gas to carry the aerosol droplets from the nebulizer, through the tubes, and to the filter. Powder formed in main pyrolysis tube was collected with a glass fiber filter having a pore diameter of 0.5 μm, which was heated to approximately 120° C. to prevent vapor condensation on the powder. The as-collected catalyst powder was post-calcinated at approximately 500° C. for 4 hours in air. The as-collected and post-calcinated catalyst powders were pre-sulfided with hydrogen gas having approximately 5 vol % of H₂S at approximately 360° C. for 2 hours prior to testing desulfurization activity.

Hydrodesulfurization of a sample of partially desulfurized straight run gas oil (DSGO) was conducted with a 100 mL batch type stirred reactor charged with 0.5 g of sulfided catalyst (NM10Si), 10 g of partially partially desulfurized straight run gas oil (having a sulfur content of 350 wt ppm sulfur) and 50 kg/cm² hydrogen at room temperature. Hydrodesulfurization was conducted at a temperature of approximately 340° C. for a reaction time of 2 hours. After 2 hours, a small amount of the product was sampled through small sampling tube. The total pressure during reaction was approximately 70 kg/cm². The feed gas oil and reaction product were analyzed by GC-AED (HP 6890+ and G2350A) to obtain total sulfur content and sulfur-specific chromatograms, as provided in Table 1.

### Example 3

### NM16Si

An aqueous solution was prepared by dissolving 1.211 g of (NH₄)₆Mo₇O₂₄.4H₂O (WAKO Chem.) and 0.721 g of Ni(NO₃)₂.6H₂O in 400 mL of water. To the aqueous solution, 5 g of silicon dioxide (Aerosil 300) was added and dispersed with the aid of an ultrasonic bath to obtain a homogeneous solution. Spray pyrolysis was carried out with an apparatus consisting of an aerosol generator, a pre-heating tube, a main pyrolysis tube and a filter. The solution was aerosolized by ultrasonic nebulizer and transported via a carrier gas to the pre-heating tube, which was maintained at approximately 200° C. The aerosolized solution was then transported to the main pyrolysis tube, which was maintained at approximately 500° C. Pure nitrogen having flow rate of 3 L/min was used as a carrier gas to carry the aerosol droplets from the nebulizer, through the tubes, and to the filter. Powder formed in main pyrolysis tube was collected with a glass fiber filter having a pore diameter of 0.5 μm, which was heated to approximately 120° C. to prevent vapor condensation on the powder. The as-collected catalyst powder was post-calcinated at approximately 500° C. for 4 hours in air. The as-collected and post-calcinated catalyst powders were pre-sulfided by hydrogen gas containing 5 vol % of H₂S at approximately 360° C. for 2 hours prior to testing desulfurization activity.

Hydrodesulfurization of a sample of partially desulfurized straight run gas oil (DSGO) was conducted with a 100 mL batch type stirred reactor charged with 0.5 g of sulfided catalyst (NM16Si), 10 g of partially partially desulfurized straight run gas oil (having a sulfur content of 350 wt ppm sulfur) and 50 kg/cm² hydrogen at room temperature. Hydrodesulfurization was conducted at a temperature of approximately 340° C. for a reaction time of 2 hours. After 2 hours, a small amount of the product was sampled through small sampling tube. The total pressure during reaction was approximately 70 kg/cm². The feed gas oil and reaction product were analyzed by GC-AED (HP 6890+ and G2350A) to obtain total sulfur content and sulfur-specific chromatograms, as provided in Table 1.

### Example 4

### NM20Si

An aqueous solution was prepared by dissolving 1.608 g of (NH₄)₆Mo₇O₂₄.4H₂O (WAKO Chem.) and 0.9572 g of Ni(NO₃)₂.6H₂O in 400 mL of water. To the aqueous solution, 5 g of silicon dioxide (Aerosil 300) was added and dispersed with the aid of an ultrasonic bath to obtain a homogeneous solution. Spray pyrolysis was carried out with an apparatus consisting of an aerosol generator, a pre-heating tube, a main pyrolysis tube and a filter. The solution was aerosolized with an ultrasonic nebulizer and transported to the pre-heating tube, which was maintained at approximately 200° C. The aerosolized solution was then transported to the main pyrolysis tube, which was maintained at approximately 500° C. Pure nitrogen having flow rate of 3 L/min was used as a carrier gas to carry the aerosol droplets from the nebulizer, through the tubes, and to the filter. The powder formed in main pyrolysis tube was collected with a glass fiber filter having a pore diameter of 0.5 μm, which was heated to approximately 120° C. to prevent vapor condensation on the powder. The as-collected catalyst powder was post-calcinated at approximately 500° C. for 4 hours in air. The as-collected and post-calcinated catalyst powders were pre-sulfided with hydrogen gas containing 5 vol % of H₂S at 360° C. for 2 hours prior to testing desulfurization activity.

Hydrodesulfurization of a sample of partially desulfurized straight run gas oil (DSGO) was conducted with a 100 mL batch type stirred reactor charged with 0.5 g of sulfided catalyst (NM20Si), 10 g of partially partially desulfurized straight run gas oil (having a sulfur content of 350 wt ppm sulfur) and 50 kg/cm² hydrogen at room temperature. Hydrodesulfurization was conducted at a temperature of approximately 340° C. for a reaction time of 2 hours. After 2 hours, a small amount of the product was sampled through small sampling tube. The total pressure during reaction was approximately 70 kg/cm². The feed gas oil and reaction product were analyzed by GC-AED (HP 6890+ and G2350A) to obtain total sulfur content and sulfur-specific chromatograms, as provided in Table 1.

### Example 5

### NM25Si

An aqueous solution was prepared by dissolving 2.181 g of (NH₄)₆Mo₇O₂₄.4H₂O (WAKO Chem.) and 1.2975 g of Ni(NO₃)₂.6H₂O in 400 mL of water. To the aqueous solution, 5 g of silicon dioxide (Aerosil 300) was added and dispersed with the aid of an ultrasonic bath to obtain a homogeneous solution. Spray pyrolysis was carried out with an apparatus consisting of an aerosol generator, a pre-heating tube, a main pyrolysis tube and a filter. The solution was aerosolized by ultrasonic nebulizer and transported via a carrier gas to the pre-heating tube, which was maintained at approximately 200° C. and then transported to the main pyrolysis tube, which was maintained at approximately 500° C. Pure nitrogen having flow rate of 3 L/min was used as a carrier gas to carry the aerosol droplets from the nebulizer, through the tubes, and to the filter. The powder formed in main pyrolysis tube was collected with a glass fiber filter having a pore diameter of 0.5 μm, which was heated to approximately 120° C. to prevent vapor condensation on the powder. The as-collected catalyst powder was post-calcinated at 500° C. for approximately 4 hours in air. The as-collected and post-calcinated catalyst powders were pre-sulfided with hydrogen gas containing 5 vol % of H₂S at 360° C. for approximately 2 hours prior to testing desulfurization activity.

Hydrodesulfurization of a sample of partially desulfurized straight run gas oil (DSGO) was conducted with a 100 mL batch type stirred reactor charged with 0.5 g of sulfided catalyst (NM25Si), 10 g of partially partially desulfurized straight run gas oil (having a sulfur content of 350 wt ppm sulfur) and 50 kg/cm² hydrogen at room temperature. Hydrodesulfurization was conducted at a temperature of approximately 340° C. for a reaction time of 2 hours. After 2 hours, a small amount of the product was sampled through small sampling tube. The total pressure during reaction was approximately 70 kg/cm². The feed gas oil and reaction product were analyzed by GC-AED (HP 6890+ and G2350A) to obtain total sulfur content and sulfur-specific chromatograms, as provided in Table 1.

### Example 6

### NMA

A commercial hydrodesulfurization catalyst obtained from a catalyst vendor containing a gamma type alumina catalyst support material, approximately 25 weight % molybdenum trioxide and approximately 5 weight % nickel oxide prepared by a conventional impregnation method, was pre-sulfided with a hydrogen gas stream containing 5 vol % of H₂S at 360° C. for approximately 2 hours prior to testing desulfurization activity.

Hydrodesulfurization of a sample of partially desulfurized straight run gas oil (DSGO) was conducted with a 100 mL batch type stirred reactor charged with 0.5 g of sulfided catalyst (NMA), 10 g of partially partially desulfurized straight run gas oil (having a sulfur content of 350 wt ppm sulfur) and 50 kg/cm² hydrogen at room temperature. Hydrodesulfurization was conducted at a temperature of approximately 340° C. for a reaction time of 2 hours. After 2 hours, a small amount of the product was sampled through small sampling tube. The total pressure during reaction was approximately 70 kg/cm². The feed gas oil and reaction product were analyzed by GC-AED (HP 6890+ and G2350A) to obtain total sulfur content and sulfur-specific chromatograms, as provided in Table 1.

TABLE 1
Remaining Total Sulfur Content

| | | Wt. ratio: | Remaining Total Sulfur | |
|---|---|---|---|---|
| | Mol ratio: | MoO₃/SiO₂ | in Product (ppm S) | |
| | Mo/Ni | support | As-collected | Post-calcinated |
| Example 1 | 2.77 | 3.5% | 268 | 243 |
| Example 2 | 2.77 | 7.6% | 244 | 138 |
| Example 3 | 2.77 | 13.2% | 228 | 111 |
| Example 4 | 2.77 | 17.5% | 27 | 57 |
| Example 5 | 2.77 | 23.7% | 33 | 55 |
| Example 6* | — | — | — | 64 |

*Example 6 is believed to consist of a weight ratio of approximately 25% MoO₃ to the support material.

As noted in Table 1, as the weight ratio of the Group VIB metal to the substrate increases, the activity of the nickel-molybdenum hydrodesulfurization catalyst prepared according to the methods described herein increases. Additionally, the results show that catalysts having a weight ratio of molybdenum to the silicon dioxide support material of greater than 17.5 wt. % perform better than a commercially available nickel-molybdenum catalyst on alumina.

Furthermore, the results show that the as-collected non-calcinated catalyst samples having a weight ratio of molybdenum to the silicon dioxide support material of greater than 17.5 wt. % have greater desulfurization activity than the calcinated samples having the same weight ratio of molybdenum to silicon dioxide. It is believed that because of the high degree of loading obtained by the methods disclosed herein, calcination of a sample having a weight ratio of molybdenum oxide to support of greater than 17.5 wt. % results in sintering of the molybdenum and nickel, thus decreasing the number of active sites on the surface of the catalyst. In contrast, at loading of less than 17.5 wt. % of molybdenum oxide to support, calcination aids in the dispersion of molybdenum and nickel, and aids in the creation of active catalyst sites. This is shown by x-ray powder diffraction, wherein calcination of samples having higher loading show the presence of bulk MoO₃.

While the invention has been shown or described in only some of its embodiments, it should be apparent to those skilled in the art that it is not so limited, but is susceptible to various changes without departing from the scope of the invention.

We claim:

1. A method for preparing a hydrosulfurization catalyst comprising:
preparing a solution comprising at least one metal salt, a catalyst support and water;
producing aerosolized droplets of the solution;
heating the droplets to produce a solid catalyst particles; and
collecting the solid catalyst particles;
wherein the metal salt comprises a first metal selected from the group consisting of chromium, molybdenum, and tungsten.

2. The method of claim 1 wherein the solution further comprises a second metal salt, wherein the second metal salt comprises a metal selected from the group consisting of iron, ruthenium, osmium, cobalt, rhenium, iridium, nickel, palladium and platinum.

3. The method of claim 1 further comprising calcinating the solid catalyst particles.

4. The method of claim 3 wherein calcinating the solid catalyst particles comprises heating the particle to a temperature greater than about 400° C.

5. The method of claim 1 further comprising partially sulfiding the catalyst particles.

6. The method of claim 5 wherein partially sulfiding the solid particles comprises contacting the particles with a hydrogen gas stream comprising hydrogen sulfide.

7. The method of claim 2 wherein the molar concentration of the first and second metal in solution is between about 0.001 and 0.05 molar.

8. The method of claim 1 wherein the molar ratio of the first metal to the second metal is between about 1.5:1 and 4:1.

9. The method of claim 1 wherein the support material has a surface area of greater than approximately 200 m²/g.

10. The method of claim 1 wherein the support material has a surface area of greater than approximately 300 m²/g.

11. The method of claim 1 wherein the support material is silicon dioxide.

12. The method of claim 1 wherein the weight ratio of the oxide form of the first metal to the catalyst support is greater than about 13 weight %.

13. The method of claim 1 wherein the weight ratio of the oxide form of the first metal to the catalyst support is between about 1% and 30%.

14. The method of claim 1 wherein the weight ratio of the oxide form of the first metal to the catalyst support is between about 13% and 23%.

15. The method of claim 1 wherein the first metal salt comprises molybdenum and the second metal salt is selected from cobalt and nickel.

16. The method of claim 1 wherein the step of producing aerosolized droplets of the solution comprises nebulizing the solution with an ultrasonic nebulizer.

17. A catalyst composition comprising:
a silicon dioxide catalyst support material;
a first metal selected from the group consisting of chromium, molybdenum and tungsten;
a second metal selected from the group consisting of iron, ruthenium, osmium, cobalt, rhenium, iridium, nickel, palladium and platinum,
wherein the first metal is present in the oxide form of the metal; and
wherein the weight ratio of the first metal to the catalyst support material is greater than about 15%.

18. The catalyst composition of claim 17 further comprising boron.

19. The catalyst composition of claim 17 further comprising phosphorous.

20. A method for the hydrodesulfurizing a petroleum based hydrocarbon distillate comprising:
contacting the petroleum hydrocarbon distillate with hydrogen gas in the presence of a hydrodesulfurization catalyst;
wherein the hydrodesulfurization catalyst comprises a silicon dioxide catalyst support material, a first metal selected from the group consisting of chromium, molybdenum and tungsten, and a second metal selected from the group consisting of iron, ruthenium, osmium, cobalt, rhenium, iridium, nickel, palladium and platinum;
wherein the catalyst is prepared by a spray pyrolysis technique.

21. The method of claim 20 wherein the spray pyrolysis technique comprises the steps of:
preparing a solution comprising a first metal salt, a second metal salt, a catalyst support and water;
producing aerosolized droplets of the solution;
heating the droplets to produce a solid catalyst particles; and
collecting the solid catalyst particles;
wherein the first metal salt comprises a first metal selected from the group consisting of chromium, molybdenum, and tungsten; and
wherein the second metal salt comprises a second metal selected from the group consisting of iron, ruthenium, osmium, cobalt, rhenium, iridium, nickel, palladium and platinum.

22. The method of claim 20 wherein the petroleum based hydrocarbon distillate is diesel.

23. The method of claim 21 wherein the first metal is molybdenum.

24. The method of claim 21 wherein the second metal is selected from cobalt and nickel.

25. The method of claim 21 wherein the catalyst support is selected from the group consisting of ultra stable Y zeolite, MCM-41 mesoporous material, B-zeolite, amorphous silica alumina, silicon dioxide, alumina, titanium dioxide, and combinations thereof.
